(19) United States
(12) Patent Application Publication
(10) Pub. No.: US 2020/0149856 A1
(43) Pub. Date: May 14, 2020

(54) Digital Step Square

(71) Applicant: Donald Miller, Knoxville, TN (US)

(72) Inventor: Donald Miller, Knoxville, TN (US)

(21) Appl. No.: 16/682,292

(22) Filed: Nov. 13, 2019

Related U.S. Application Data
(60) Provisional application No. 62/760,632, filed on Nov. 13, 2018.

(51) Int. Cl. G01B 3/56; G01B 3/06; G01C 9/34

(52) U.S. Cl. CPC G01B 3/56; G01C 9/34; G01B 3/06

(57) ABSTRACT

A carpentry device including a main arm having a width and length configured to measure distances of an object. The main arm can include indicia markings on a face of the main arm for measuring distances of an object. The main arm can be formed from one or more sections configured to extend or retract in a longitudinal direction, including at least one supplemental arm extending from at least one connection point at an end of the main arm such that the at least one supplemental arm can rotate about the at least one connection point. A digital angle finder can be attached to the at least one connection point to display an angle between the at least one connection point and the main arm. A bubble level can be attached to the face of the main arm.

### CROSS-REFERENCE TO RELATED APPLICATIONS

This application claims the benefit of U.S. Provisional Application No. 62/760,632 filed on Nov. 13, 2018, the disclosure of which is hereby incorporated by reference herein in its entirety.

### FIELD OF INVENTION

The present general inventive concept relates to a tool for measuring angles and distances and, more particularly, to a step square using a digital angle finder to provide precise angle measurements for stair risers and treads and other carpentry work.

### BACKGROUND

The carpenter square has proven effective in providing a tool for laying out and marking patterns in framing, roofing and stairway work. These tools can also be effective for additional uses in measurement, including measuring different angles. Typically, the carpenter square consists of a longer main arm, and a shorter, narrower arm, and the two arms meet at a right angle. It has been a challenge to enable carpenters to accurately and efficiently measure various angles of two pivoting arms in relation to the main arm and measure precise levels of steps, risers, etc. and other carpentry work.

### BRIEF SUMMARY

Embodiments of the present general inventive concept can include digital angle finders incorporated into the tool for providing clear and accurate measurements of the angles of the two pivoting supplemental arms in relation to the main arm and each other. The device can also include leveling devices such as bubble levels to accurately measure levels in conjunction with the angle measurements.

Example embodiments of the present general inventive concept can be achieved by a device for performing carpentry work, including a main arm having an extendable length suitable to measure distances of an object, the main arm including indicia markings on a surface of the main arm indicating distance from a reference point relative to the main arm. The device can include at least one supplemental arm pivotally connected to an end of the main arm at a connection point, the at least one supplemental arm being configured to rotate about the connection point, a digital angle finder configured to measure and display an angle between the at least one supplemental arm and the main arm, and a bubble level configured to indicate whether the device is level or plumb and/or the angle measurement of the device away from level or plumb.

Example embodiments can provide a device for performing carpentry work, comprising: a main arm having a width and length configured to measure distances in an object, the main arm including indicia markings on the face of the main arm indicating distance from a reference point, the main arm formed from one or more sections configured to extend or retract in a longitudinal direction; channels in the one or more sections, a bolt inserted into the channel, configured to secure each section to an adjacent section, at least one supplemental arm extending from at least one connection point at the end of the main arm, the at least one supplemental arm configured to rotate about the at least one connection point, a digital angle finder attached to the at least one connection point, configured to display the angle between the at least one connection point and the main arm, and a bubble level configured to indicate whether the device is level or plumb, or the angle measurement of the device away from level or plumb.

Additional features and embodiments of the present general inventive concept will be set forth in part in the description which follows, and, in part, will be obvious from the description, or may be learned by practice of the present general inventive concept.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying images, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying images in which:

FIG. 1 is a front view of a digital step square according to example embodiments of the present general inventive concept;

FIG. 2 is a close-up view of a digital step square according to example embodiments of the present general inventive concept;

FIG. 3 is a perspective view of a digital step square being used on a stairway according to example embodiments of the present general inventive concept;

FIG. 4 is a perspective view of a digital step square being used on a stairway according to example embodiments of the present general inventive concept;

FIG. 5 is a perspective view of a digital step square being used on a baseboard moulding according to example embodiments of the present general inventive concept; and

FIG. 6 is a perspective view of a digital step square being used on a stairway according to example embodiments of the present general inventive concept.

### DETAILED DESCRIPTION

Example embodiments of the present general inventive concept provide a new and improved digital step square, utilizing a main arm having a width and length configured to measure distances in a step, shelf, or other object, one or two supplemental arms extending from at least one connection point at the end of the main arm, a digital angle finder attached to the connection point, configured to display the angle between the at least one connection point and the main arm, and a bubble level configured to indicate whether the device is level or plumb, or the angle measurement of the device away from level or plumb.

In some embodiments, the device can be used to assist in measuring and aligning tools that could facilitate the fabrication of stair treads and risers. It may be fabricated of aluminum, or other materials, and may feature a transverse bar. For example, this may consist of a two or more piece, or section, telescoping design that can be adjusted over a range of lengths, for example, from 32 to 48 inches, or more. Located at its outer ends may be a pair of digital angle finders. The corners and center of each unit may also be equipped with handles to aid in positioning.

In some embodiments of the present general inventive concept, the main arm can consist of one or more sections which allow the user to extend the main arm to a length corresponding with a step to be measured. For example, the length of the sections can be 32 inches each, and the overall length of the transverse bar can be extendable from 32 inches to 48 inches or more, although the lengths are not limited to any particular length or dimension, and any number of other measurements can be utilized, depending on the number of telescoping sections chosen for the transverse arm. In one embodiment, each section of the main transverse telescoping arm can be positioned such that each section is lined up directly above another section, in a stacked fashion to facilitate adjustment. A longitudinal channel can be provided in one of the sections, extending part of the length of the section. A bolt can be inserted through the channel in order to secure the top section to a lower section. A knob attached to the bolt can be provided which allows the user to loosen and tighten the bolt freely. By loosening the bolt, the user can then move one section freely in a longitudinal direction relative to the other section in order to extend the main arm to a desired distance. Other attachment devices can also be used including screws, pins, clips, etc.

In other embodiments, a section of the main arm can extend telescopically from one or more other sections. The user can then move one section freely in a longitudinal direction relative to the other section in order to extend the main arm to a desired distance. In some embodiments, the sections can be formed to fit snugly within each other section, so that excessive and undesired movement of the sections relative to each other is constrained. In other embodiments, a clip can be provided at the end of each section, which can be engaged once the user has extended each section to a desired length. Other securing devices such as a pin and spring combination are also possible.

Indicia markings can be provided on the face of each section of the main arm, in order to provide the user with distance measurements. These indicia markings can be shown in inches, centimeters, or other units of measurement. In order to determine the total length of the main arm, the user can add the measurements of each section as indicated by the indicia markings on each section. In other embodiments of the invention a digital display can show the precise measurement of the main arm when extended to a desired length. Such a display can be liquid crystal display (LCD), light-emitting diode (LED), or other technologies.

In some embodiments, a level can be placed on the main arm in order to indicate whether the main arm, and the object on which it is placed, is level or plumb, or the angle measurement of the device away from level or plumb. Such a level can be a bubble level, a laser level, a digital level, or other such devices known within the art. The level can reside on top of the main arm, or can be embedded in the main arm in order to save space on the device.

In some embodiments of the present general inventive concept, at least one supplemental arm can extend from either end of the main arm. These supplemental arms can be smaller than the main arm in both width and length. The supplemental arms can contain indicia markings on their face in order to indicate distance measurements. The supplemental arms can be connected to a section of the main arm by means of a threaded bolt, screw, pin, or other attachment device known in the art. The supplemental arms are configured to rotate in relation to the main arm. A digital angle finder can be attached to the connection point between the supplemental arm and the main arm in order to provide an angle measurement of the relative angular position of the supplemental arm and the main arm. An adjustable knob can be attached to the connection bolt in order to control the tension between the supplemental arm and the main arm, and the freedom of rotation. In other embodiments, the at least one supplemental arm can be configured to move in an indexed fashion relative to the main arm so that the supplemental arm clicks into any number of desired positions, as is known in the art.

In one embodiment, the device may be place on the tread or riser area in question and the supplemental arms extended until they rest against the wall or stringer. The digital angle finders may pivot outward. The length and end angles can be read off the unit or can be placed upon the stock in question and its outer ends used to mark the stock with a pencil. The tread or riser may then be cut to the desired width.

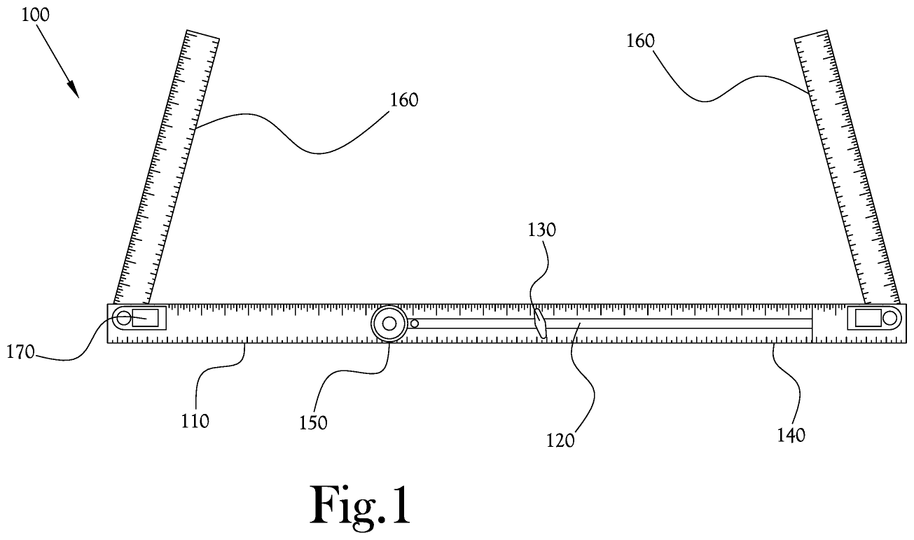

Referring to FIG. 1, shown is a digital step square 100 according to some embodiments of the present general inventive concept. As shown in this embodiment, the main arm 110 contains two sections which line up one section on top of the other section, although any number of sections are possible. A channel 120 can be cut in one of the sections in which can reside a bolt (not shown in the figure) or other attachment device to secure the sections together. A knob 130 can be attached to one end of the bolt which can facilitate securing the sections by hand. Indicia markings 140 including inches and centimeters can be provided on the face of the sections of the main arm to indicate distance measurement. Shown in this embodiment is a bubble level 150 which rests on the face of one of the sections and can protrude several millimeters above the section. In other embodiments, the bubble level 150 can be embedded within one of the sections so that it rests flush with its face. Two supplemental arms 160 are shown in an open position extending from the main arm 110. At the connection point of each supplemental arm 160 with the main arm 110 resides a digital angle finder 170 which displays the angular position of the supplemental arm 160 relative to the main arm 110.

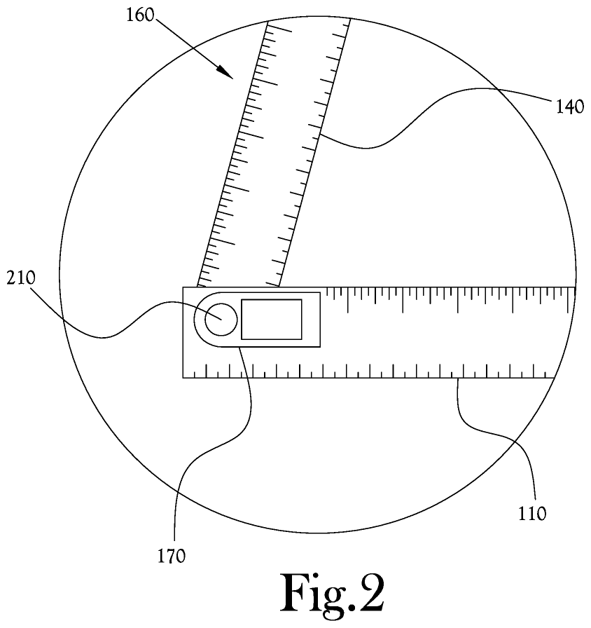

FIG. 2 shows a close-up view of one embodiment of the present general inventive concept. The digital angle finder 170 is shown which displays the angular position of the supplemental arm 160 relative to the main arm 110. Also visible in the figure are the indicia markings 140. The supplemental arms can be connected to a section of the main arm by an attachment device 210 such as a threaded bolt, screw, pin, or other attachment device known in the art

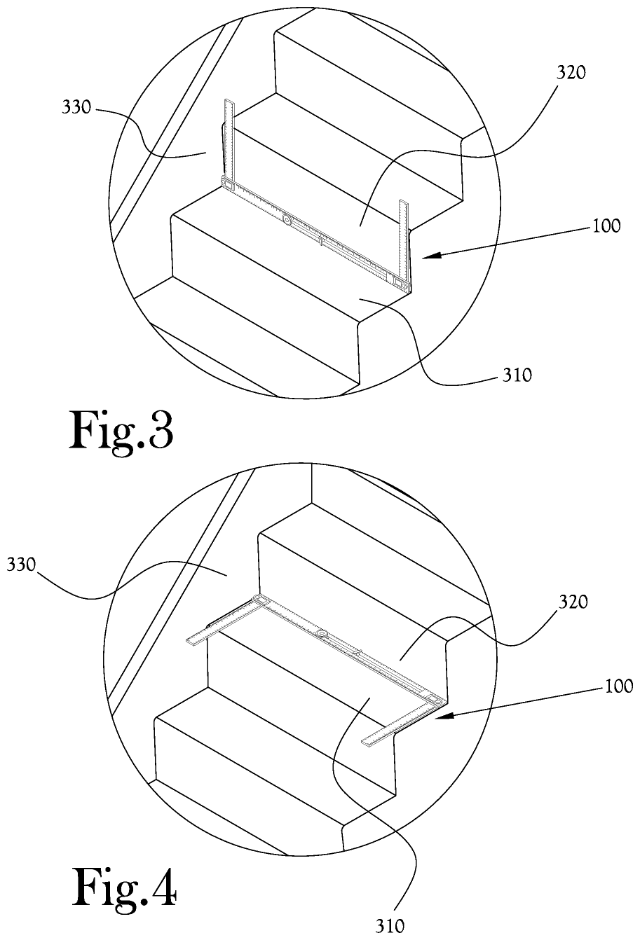

Shown in FIG. 3 is a view of the digital step square 100, with the supplemental arms 160 in the open position, in a generally 90 degree angle with the main arm 110, and the main arm 110 is resting on the stair tread 310. The supplemental arms 160 are in a vertical position and the device is measuring the stair riser 320. The digital angle finder 170 in that case is measuring the angle between the stair tread 310 and the stringer 330.

Shown in FIG. 4 is a digital step square 100 according to one embodiment of the present general inventive concept. In this figure, the supplemental arms 160 are in the open position in a generally 90 degree angle with the main arm 110, and the main arm 110 is resting on the stair tread 310. The supplemental arms 160 are in a horizontal position and the device is measuring the stair tread 310. The digital angle finder 170 in that case is measuring the angle between the stair riser 320 and the stringer 330.

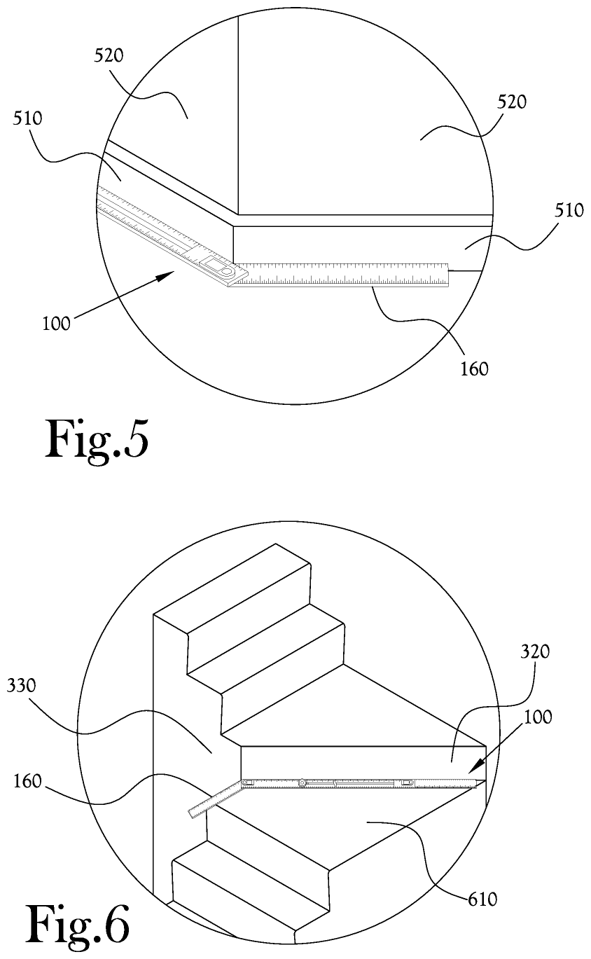

Shown in FIG. 5 is a digital step square 100 according to one embodiment of the present general inventive concept. In this figure, one supplemental arm 160 is in the open position with an angle greater than 90 degrees. The digital step square 100 is resting on the floor and the digital angle finder 170 in that case is measuring the angle between baseboards 510 resting against two walls 520.

Shown in FIG. 6 is a digital step square 100 according to one embodiment of the present general inventive concept. In this figure, one supplemental arm 160 is in the open position in a generally greater than 90 degree angle with the main arm 110, and the main arm 110 is resting on the stair landing 610. The supplemental arms 160 are in a horizontal position and the device is measuring the stair landing 610. The digital angle finder 170 in that case is measuring the angle between the stair riser 320 and the stringer 330.

Example embodiments of the present general inventive concept can provide precise angle measurements for stair risers and treads, and other carpentry work. The compact size of example embodiments of the present general inventive concept allows it to be stored conveniently and be ready for use. Other features and/or advantages will be recognized in the descriptions of example embodiments of the present general inventive concept contained herein. Such a device and system can present enhanced functionality in a host of carpentry applications such as, for example, building stairs, shelving, furniture, etc.

Various example embodiments of the present general inventive concept provide a lightweight and economical device, or tool, to allow a carpenter to quickly and accurately manipulate two arms which rotate off the main arm, and provides for an unlimited number of angles of the two supplemental arms in relation to the main arm, and provide for efficiency of measurement when doing carpentry work. A digital angle finder is incorporated in the tool for providing clear and accurate measurements of the angles of the two supplemental arms in relation to the main arm. without having to locate and manipulate different tools.

Such a device may provide an accurate and easy to use means of establishing the widths and end angles of stair treads and risers. It may be adjusted for use on most staircases and could compensate for warped or misaligned stringers or related issues. As an added feature, a ruler may not be needed.

Such a device can provide accurate measurements and be produced in an economic fashion. It effectively eliminates the need to use multiple different tools. Such a device/system increases efficiency while also lowering cost.

It is noted that the simplified diagrams and drawings do not illustrate all the various connections and assemblies of the various components, however, those skilled in the art will understand how to implement such connections and assemblies, based on the illustrated components, figures, and descriptions provided herein. Accordingly, while the present general inventive concept has been illustrated by description of several example embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

1. A device for measuring carpentry work, comprising:
a main arm having an extendable length suitable to measure distances of an object, the main arm including indicia markings on a surface of the main arm indicating distance from a reference point relative to the main arm;
at least one supplemental arm pivotally connected to an end of the main arm at a connection point, the at least one supplemental arm being configured to rotate about the connection point;
a digital angle finder configured to measure and display an angle between the at least one supplemental arm and the main arm; and
a bubble level configured to indicate whether the device is level or plumb and/or the angle measurement of the device away from level or plumb.

2. A device for measuring carpentry work, comprising:
a main arm having a width and length configured to measure distances of an object, the main arm including indicia markings on a face of the main arm indicating distance from a reference point;
the main arm formed from one or more sections configured to extend or retract in a longitudinal direction;
a channel in the one or more sections;
a fastening device configured to cooperate with the channel to releasably secure each section to an adjacent section;
at least one supplemental arm extending from at least one connection point at a first end of the main arm, the at least one supplemental arm configured to rotate about the at least one connection point;
a digital angle finder attached to the at least one connection point, the digital angle finder configured to display an angle between the at least one supplemental arm and the main arm; and
a bubble level attached to the face of the main arm to indicate whether the device is level or plumb, or an angle measurement of the device away from level or plumb.

3. The device of claim 2, further comprising another supplemental arm extending from at least one connection point at a second end of the main arm opposite the first end, the another supplemental arm configured to rotate about the at least one connection point at the second end; and
another digital angle finder attached to the at least one connection point at the second end, the another digital angle finder configured to display an angle between the another supplemental arm and the main arm.
